(19) United States
(12) Patent Application Publication
(10) Pub. No.: US 2015/0073666 A1
(43) Pub. Date: Mar. 12, 2015

(54) ADJUSTING APPARATUS FOR MOVING A VEHICLE PART THAT CAN BE MOVED BETWEEN A CLOSED POSITION AND AN OPEN POSITION

(71) Applicant: BROSE FAHRZEUGTEILE GMBH & CO. KOMMANDITGESELLSCHAFT. HALLSTADT, HALLSTADT (DE)

(72) Inventors: GUENTHER DOTTERWEICH, NEUNKIRCHEN AM BRAND (DE); SEBASTIAN TROMBKE, HIRSCHAID (DE)

(21) Appl. No.: 14/484,508

(22) Filed: Sep. 12, 2014

(30) Foreign Application Priority Data
Sep. 12, 2013 (DE) 102013015119.8

(51) Int. Cl. E05F 15/20

(52) U.S. Cl. CPC E05F 15/20; E05F 15/2092; E05F 15/2023
USPC 701/49

(57) ABSTRACT

An adjusting apparatus moves a vehicle part that can be moved between a closed position and an open position with a servomotor for producing an adjusting force. An input interface accepts an input by a vehicle user as a basis for outputting a first control signal or a second control signal. The adjusting apparatus includes a control unit for actuating the servomotor. The control unit is set up to respond to the first control signal by actuating the servomotor directly to move the vehicle part into the closed position. The control unit is also set up to respond to the second control signal by actuating the servomotor to move the vehicle part into the closed position only when at least one additional prescribed criterion is met.

### CROSS-REFERENCE TO RELATED APPLICATION

This application claims the priority, under 35 U.S.C. §119, of German patent application DE 10 2013 015 119.8, filed Sep. 12, 2013; the prior application is herewith incorporated by reference in its entirety.

### BACKGROUND OF THE INVENTION

1. Field of the Invention

The invention relates to an adjusting apparatus for moving a vehicle part that is movable, in particular automatically, between a closed position and an open position.

In modern vehicles, adjustable vehicle parts are increasingly driven by a servomotor in order to increase user convenience for a vehicle user. An adjustable vehicle part of this kind is particularly a side window, a sliding roof or—with increasing frequency—a vehicle door. In that case, the movement of the respective vehicle part is conventionally initiated in response to an input from the vehicle user on an input interface (e.g. a switch or pushbutton switch). The switch or pushbutton switch may be arranged on the vehicle itself or, by way of example, on a (radio) remote control (usually combined with the vehicle key). In the meantime, to allow the vehicle user to make an adjustment request, sensor systems are also known that react to motion from the vehicle user. These afford the advantage that the vehicle user is able, particularly when loading the vehicle, to open the trunk, for example, without having to manually operate a switch. However, such sensor systems are also comparatively expensive and complex.

### SUMMARY OF THE INVENTION

It is accordingly an object of the invention to provide an adjusting apparatus for a vehicle part which overcomes the disadvantages of the heretofore-known devices of this general type and which provide for a further increase in user convenience for the vehicle user.

With the above and other objects in view, there is provided, in accordance with the invention, an adjusting apparatus for moving a vehicle part that can be moved between a closed position and an open position. The novel adjusting apparatus comprises:
a servomotor for generating an adjusting force for moving the vehicle part;
an input interface configured to acquire an input from a vehicle user as a basis for outputting a first control signal or a second control signal; and
a control unit for actuating the servomotor, the control unit being configured to respond to the first control signal by actuating the servomotor directly for moving the vehicle part into the closed position, and the control unit being configured to respond to the second control signal by actuating the servomotor for moving the vehicle part into the closed position when at least one additional prescribed criterion is met.

The adjusting apparatus according to the invention is set up and provided for the purpose of moving a vehicle part that can be moved between a closed position and an open position. To this end, the adjusting apparatus comprises a servomotor for generating an adjusting force (that acts on the vehicle part in order to move it) and also an input interface that is set up to take an input by a vehicle user as a basis for outputting a first control signal or a second control signal. Furthermore, the adjusting apparatus includes a control unit for actuating the servomotor.

The control unit is configured (by virtue of circuitry or programming) to respond to the first control signal from the input interface by actuating the servomotor directly to move the vehicle part from an at least partially open position (but preferably from the open position) into the closed position. According to the invention, the control unit is furthermore configured to respond to the second control signal by actuating the servomotor to move the vehicle part into the closed position when at least one additional prescribed criterion is met. That is to say, the first control signal is used by the control unit for the purpose of directly (that is to say immediately) closing the vehicle part, whereas in response to the second control signal, before the vehicle part is closed, there is initially provision for the additional criterion to be checked.

By way of example, the input interface is a switch or a pushbutton switch that is preferably arranged on the vehicle part itself. Alternatively, however, the invention may provide for the input interface to be arranged on another, further vehicle part, for example one adjoining the movable vehicle part, or on a (radio) remote control associated with the vehicle.

Within the context of the invention, the control unit may be in the form of a nonprogrammable electronic circuit and, in this case, integrated in control for the servomotor, for example. Preferably, the control unit is formed by a microcontroller, however, in which the functionality for actuating the servomotor in accordance with the invention is implemented in the form of a software module. In this case, the software module can particularly form part of comprehensive control software (firmware) for the control of the servomotor.

The first and second control signals are preferably a prescribed signal value for an electrical voltage. The signal value is applied between the input interface and the control unit. In this case, the input interface is preferably set up such that the input from the vehicle user is reproduced directly by the first and second control signals. That is to say that, by way of example, brief pressure on a switch forming the input interface applies the signal value for a correspondingly short time. In this case, the control unit is set up particularly to distinguish the first control signal from the second control signal on the basis of the time characteristic of said first control signal. By way of example, the control unit does so by checking whether the voltage applied between the control unit and the input interface returns from the signal value to the initial value again within a prescribed time window, or whether the signal value is applied at least until the end of the time window. In this instance, the time window is preferably approximately 1 to 3 seconds long. In this case, the control unit thus distinguishes between a long signal (e.g. at least one second) and a short signal. Alternatively, the control unit checks whether the signal value is applied a plurality of times, particularly twice, within the time window. By way of example, the control unit classifies dual (or long) detection of the voltage value as a first control signal and then moves the vehicle part directly. Correspondingly, the control unit classifies single (or brief) detection of the voltage value as a second control signal and then checks whether the additional criterion is met. Within the context of the invention, however, it is also possible for the control unit to classify the first and second control signals correspondingly conversely and hence to respond to single (or brief) detection of the voltage value by moving the vehicle part directly and to dual (or long) detection by moving it after the additional criterion is met.

In order to distinguish between the first and second control signals, it is alternatively also conceivable within the context of the invention for the input interface to comprise a first pushbutton switch (or switch) for outputting the first control signal and a second pushbutton switch for outputting the second control signal. In this case, the control unit preferably distinguishes between the two control signals on the basis of the association between the respective control signal and the first or second pushbutton switch (e.g. by means of two respective associated signal inputs).

The movable vehicle part is preferably a vehicle door, particularly a tailgate (also called trunk door or trunk lid).

The distinction between direct movement and movement that is dependent on an additional criterion provides the vehicle user with at least two options for initiating movement of the vehicle part. This allows particularly flexible operation of the vehicle part, particularly the vehicle door, which in turn increases user convenience for the vehicle user.

In a preferred embodiment, the control unit is particularly set up to use the expiry of a prescribed waiting time as an additional criterion. In other words, upon receiving the second control signal, the control unit starts the prescribed waiting time and actuates the servomotor to close the vehicle part only when the waiting time has elapsed—that is to say with a time delay. This is advantageous particularly for the case in which the vehicle part is the vehicle door, particularly the tailgate. In this case, the vehicle user can initiate the second control signal—with his hands free—before the vehicle is unloaded, for example, and can then use both hands to remove one or more articles from the vehicle without having to keep one hand free for operating the vehicle door (that is to say without having to put down the cargo, for example, in order to operate the vehicle door). In this case, the waiting time is preferably chosen such that the vehicle user, having grasped the articles, can step out of the swivel region of the vehicle door or the tailgate before it automatically closes. In this case, the waiting time is 2 to 20 seconds, preferably 5 to 10 seconds.

In principle, the waiting time may, within the context of the invention, be firmly prescribed (stored) in the control unit by the factory. In an optional embodiment, however, the control unit is set up to store the waiting time on a user-specific basis in a setting mode, so that the waiting time can be individually prescribed by a vehicle user for the subsequent adjustment operations. By way of example, the vehicle user can in this case prescribe the waiting time using an onboard computer of the vehicle, which is superordinate to the control unit, or using an input on the input interface (for example by pushing the pushbutton switch that possibly forms the input interface for a particularly long time).

In one variant of the invention, whenever the second control signal is output (that is to say whenever the key is pushed for a long time, for example), the waiting time is set again on the basis of the duration of the second control signal (that is to say the duration for which the key is pushed, for example). Within the context of the invention, a 1:1 relationship may be prescribed between the duration of the second control signal and the waiting time, so that the waiting time corresponds precisely to the duration of the second control signal. To set a waiting time of 5 seconds, the user needs to keep the pushbutton switch pushed for a period of 5 seconds, for example. Preferably, the waiting time is linked to the duration of the second control signal by means of a factor that is different than one, however, for example by means of a factor having the value 3. In the latter case, the user needs to keep the pushbutton switch pushed for a period of 4 seconds in order to set a waiting time of 12 seconds.

In another variant of the invention, the user can set the waiting time in a storage mode of the adjusting apparatus, and the waiting time that has been set in this manner is then stored by the adjusting apparatus for retrieval by means of the second control signal. If the user has set a waiting time of 10 seconds in the storage mode, for example, this waiting time is retrieved and observed by the adjusting apparatus whenever the user later initiates the second control signal.

In this variant too, the waiting time in the storage mode of the adjusting apparatus is advantageously set by means of the input interface, that is to say the pushbutton switch, for example. In this case, within the context of the invention, the waiting time to be set may in turn be correlated to the duration of the control signal initiated via the input interface by means of a 1:1 relationship or a factor that is different than 1.

In an additional or alternative refinement, the control unit is set up to use a signal from a distance sensor, which signal is characteristic of the absence of an obstacle in the adjustment path of the vehicle part, as a (possibly further) additional criterion. In this case, the adjusting apparatus is set up particularly to initiate the closing operation (that is to say to actuate the servomotor) only if the adjusting path of the vehicle part is preferably completely free. In this context, “completely free” is understood to mean that no obstacle is arranged within the entire adjusting path arranged between the stationary vehicle part and the closed position. In a simple embodiment, the distance sensor is directly associated with the adjusting apparatus, that is to say forms part of the adjusting apparatus. In an alternative embodiment, the adjusting apparatus resorts to the signal from a separate distance sensor, which is preferably associated with a pinching prevention apparatus—that is frequently existent anyway on an automatically movable vehicle door. Alternatively, within the context of the invention, the distance sensor may also be associated with a parking aid as what is known as a “parking sensor.” In this case, the distance sensor is preferably used to ascertain whether the vehicle user is located within a prescribed region around the vehicle, within which the vehicle user can be sensed by said distance sensor when the vehicle part is being closed. In addition, within the context of the invention, it is also conceivable for the distance sensor to be in the form of part of a motion-sensitive door opening apparatus that responds to motion from the vehicle user that is detected by means of the distance sensor by moving, in particular opening, the vehicle part. By way of example, the distance sensor is a capacitive distance sensor, an optical sensor or another (contactlessly measuring) sensor that can be used to ascertain the distance from an object, preferably over the entire adjusting path. This embodiment increases not only user convenience but also user safety for the vehicle, since the vehicle part is closed only when the vehicle user has removed himself from the adjusting path of the vehicle part, particularly from the swivel region of the vehicle door—possibly also only after the waiting time has elapsed.

Within the context of the invention, it is furthermore also conceivable for the adjusting apparatus according to the invention to be combined with a keyless access function (what is known as a “Keyless Entry”/“Keyless Go” function). In the case of such a keyless access function, a closing installation in the vehicle checks whether a radio key associated with the vehicle is situated within a prescribed region around the vehicle. If the presence of the radio key is detected, the closing installation automatically unlocks the vehicle (that is to say the vehicle doors) without the vehicle user having to perform an active action. When the radio key is removed from the prescribed region, the closing installation automatically locks the vehicle. In this case, the control unit is set up particularly to use a (key) signal—indicative of the absence of the radio key—from the closing installation as an additional criterion. In other words, the adjusting apparatus responds to the second control signal by closing the vehicle part only when the vehicle user with the vehicle key has removed himself from the prescribed region around the vehicle. Preferably, the adjusting apparatus uses the removal of the radio key from the prescribed region as a criterion for closing the vehicle part only in the event of the radio key already having been situated within the prescribed region when the input interface is operated. In this case, the prescribed region preferably corresponds to a zone of, by way of example, one meter around the vehicle part (particularly around the tailgate).

In order to signal particularly the detection of the second control signal (and hence the corresponding input on the input interface) to the vehicle user, the control unit is set up, in an optional refinement, to respond to the second control signal by using a signaling unit to output a confirmation signal. The confirmation signal is preferably provided as an audible signal, for example in the form of a beep. In this case, the signaling unit is in the form of a loudspeaker. Within the context of the invention, the signaling unit may also be in the form of a light source (e.g. LED), however, that is associated with the input interface. In this case, the confirmation signal is a visual signal. In addition, within the context of the invention, the confirmation signal may also be provided as a haptic signal. This is advantageous particularly for the case in which the input interface is arranged on the remote control of the vehicle. By way of example, provision is made for the remote control to vibrate as a confirmation signal in this case.

Other features which are considered as characteristic for the invention are set forth in the appended claims.

Although the invention is illustrated and described herein as embodied in an adjusting apparatus for moving a vehicle part that can be moved between a closed position and an open position, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a schematic side view of the rear of a vehicle with an open tailgate and also with an adjusting apparatus for automatically moving the tailgate,

FIG. 2 shows a schematic flowchart for the adjusting method performed by the adjusting apparatus, and

FIG. 3 shows an alternative exemplary embodiment of the adjusting apparatus in a view as per FIG. 1.

Mutually corresponding parts and variables are provided with the same reference symbols throughout all the figures.

### DETAILED DESCRIPTION OF THE INVENTION

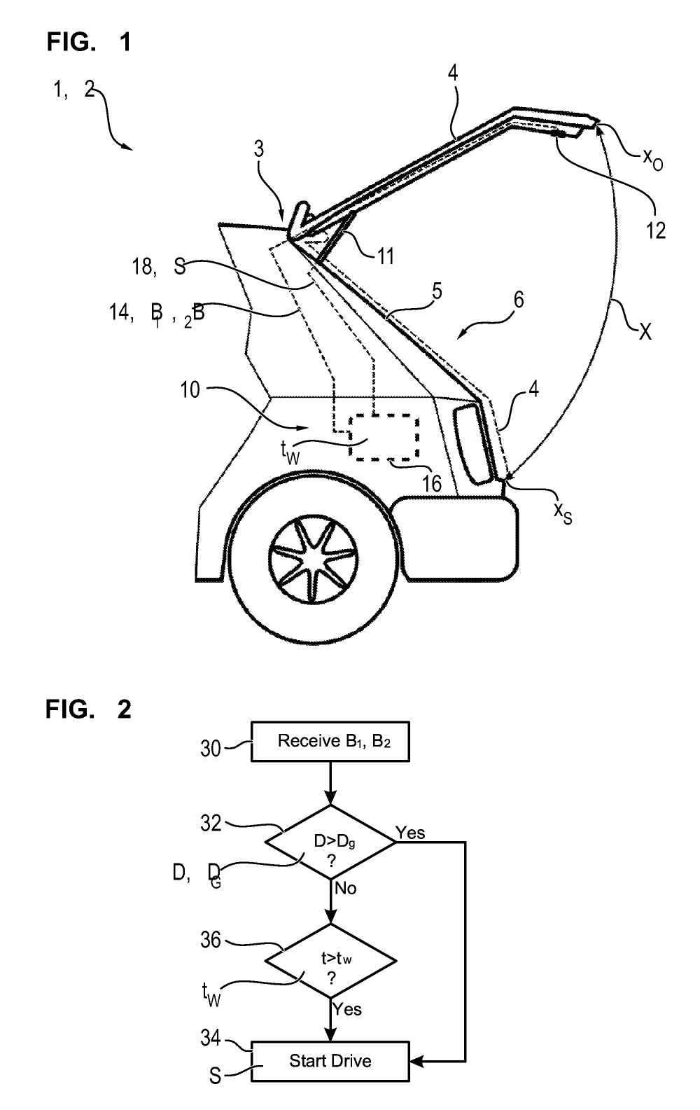

Referring now to the figures of the drawing in detail and first, particularly, to FIG. 1 thereof, there is shown a schematic view of the rear 1 of a vehicle 2. A tailgate 4 is articulated at a top edge 3 of the rear 1 so as to be able to pivot. The tailgate 4 is therefore a movable vehicle part. The tailgate 4 can be moved between an open position x_{O} and a closed position x_{S} along an adjusting path X. In the closed position x_{S}, the tailgate 4 is in contact with a closing edge 5 of the rear 1 and in that state closes up a trunk opening 6.

For the purpose of automatically moving the tailgate 4, the vehicle 2 has an adjusting apparatus 10. The adjusting apparatus 10 comprises a servomotor that is in the form of a spindle drive 11, which acts on the tailgate 4 in the region of the upper edge 3. Furthermore, as an input interface for a vehicle user, the adjusting apparatus 10 includes a pushbutton switch 12 that is arranged on the inside of the tailgate 4 which faces the vehicle 2. The pushbutton switch 12 is connected to a control unit 16 of the adjusting apparatus 10 by way of a signal line 14. The control unit 16 is provided for the purpose of actuating the spindle drive 11 and, to this end, is coupled thereto by way of a control line 18.

Furthermore, the control unit 16 is configured to perform an adjusting method, described in more detail in FIG. 2, for moving the tailgate 4. In this case, the control unit 16 responds to a first control signal B₁, which is output by the pushbutton switch 12 as a result of an appropriate input from a vehicle user thereon, by starting the movement of the tailgate 4 from the open position x_{O} into the closed position x_{S} (that is to say the closing of the tailgate 4) directly, i.e. immediately. In response to a second control signal B₂, the control unit 16 initiates the closing of the tailgate 4 with a time delay, on the other hand, i.e., after a waiting time t_{W} has elapsed. In order to close the tailgate 4, the control unit 16 transmits a closing signal S to the spindle drive 11 via the control line 18 in this case.

Specifically, the control unit 16 starts the adjusting method shown in FIG. 2 in a first method step 30 upon reception of a signal (the first or the second control signal B₁ or B₂) from the pushbutton switch 12. In this case, the control unit 16 distinguishes the first control signal B₁ from the second control signal B₂ on the basis of the respective signal duration D. To this end, the control unit 16 uses the second method step 32 to check whether the signal duration D is longer or shorter than a prescribed limit duration D_{G}, and on the basis of this check assesses whether the signal is the first control signal B₁ or the second control signal B₂. In this case, the signal is interpreted as the first control signal B₁ if the signal duration D is longer than the prescribed limit duration D_{G} (D>D_{G}). In this case, the control unit 16 moves directly to an adjusting step 34, in which the control unit 16 outputs the adjusting signal S to the spindle drive 11. Otherwise, i.e. if the signal duration D is shorter than the prescribed limit duration D_{G} (D<D_{G}), the control unit 16 interprets the signal as the second control signal B₂ and moves to a third method step 36. In this method step 36, the control unit 16 waits until the prescribed waiting time t_{W} has elapsed and moves to the adjusting step 34 only when the waiting time t_{W} has elapsed. The tailgate 4 is thus closed in response to the second control signal B₂ only after a time delay.

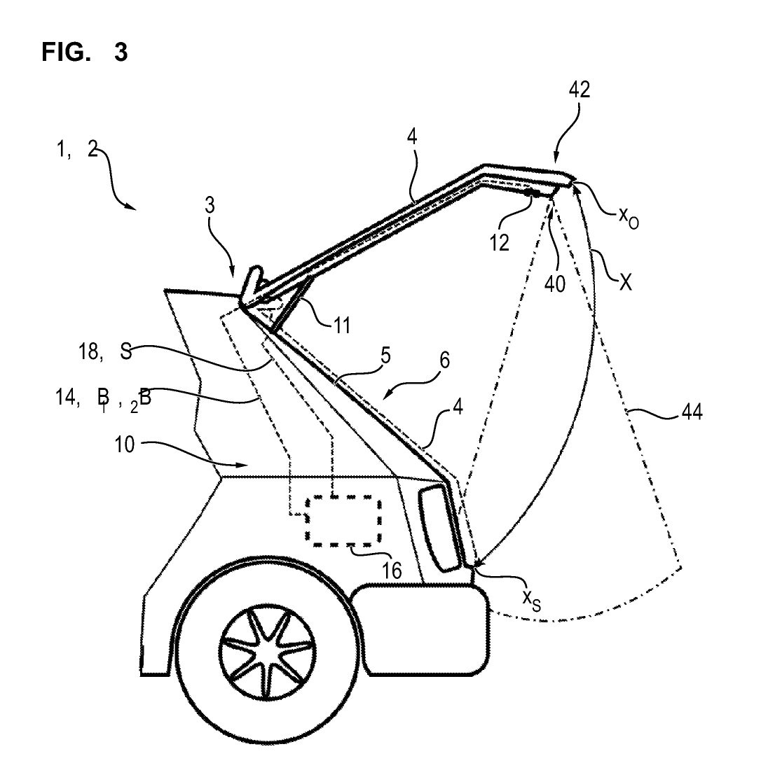

In an alternative exemplary embodiment as shown in FIG. 3, the adjusting apparatus 10 additionally comprises a contactless distance sensor 40 (e.g. a laser scanner) that is arranged at a lower edge 42 of the tailgate 4 and the measurement field 44 of which is indicated by a dash-dot line. In this embodiment, the control unit 16 is set up to respond to the second control signal B₂ by using the distance sensor 40 to check whether the entire adjusting path X, that is to say the region between the open position x_{O} and the closed position x_{S}, is completely free of obstacles. Only if no obstacle is detected in the measurement field 44 does the control unit 16 output the adjusting signal S to the spindle drive 11.

In a further exemplary embodiment, which is not shown in more detail, the control unit 16 uses the third method step 36 to first of all check whether the prescribed waiting time t_{W} has elapsed. The control unit 16 then additionally uses the distance sensor 40 to check whether the adjusting path X is completely free, and enables the movement, i.e. the control unit 16 outputs the adjusting signal S to the spindle drive 11 in the adjusting step 34, only if both criteria are met.

The subject matter of the invention is not limited to the exemplary embodiments described above. Instead, further embodiments of the invention can be derived by a person skilled in the art from the description above. In particular, the individual features of the invention, and the variant refinements thereof, that are described on the basis of the various exemplary embodiments can also be combined with one another in other ways.

The following is a summary list of reference numerals and the corresponding structure used in the above description of the invention:
1 Rear
2 Vehicle
3 Upper edge
4 Tailgate
5 Closing edge
6 Trunk opening
10 Adjusting apparatus
11 Spindle drive
12 Pushbutton switch
14 Signal line
16 Control unit
18 Control line
30 Method step
32 Method step
34 Adjusting step
36 Method step
40 Distance sensor
42 Lower edge
44 Measurement field
X Adjusting path
x_{O} Open position
x_{S} Closed position
B₁ Control signal
B₂ Control signal
S Closing signal
t_{W} Waiting time
D Signal duration
D_{G} Limit duration

1. An adjusting apparatus for moving a vehicle part that can be moved between a closed position and an open position, the adjusting apparatus comprising:
a servomotor for generating an adjusting force for moving the vehicle part;
an input interface configured to acquire an input from a vehicle user as a basis for outputting a first control signal or a second control signal; and
a control unit for actuating the servomotor, said control unit being configured to respond to the first control signal by actuating said servomotor directly for moving the vehicle part into the closed position, and said control unit being configured to respond to the second control signal by actuating said servomotor for moving the vehicle part into the closed position when at least one additional prescribed criterion is met.

2. The adjusting apparatus according to claim 1, wherein said control unit is configured to use an expiry of a prescribed waiting time as the additional criterion.

3. The adjusting apparatus according to claim 2, wherein said control unit is configured to store the waiting time on a user-specific basis in a setting mode.

4. The adjusting apparatus according to claim 1, which further comprises a distance sensor disposed to ascertain whether or not an obstacle is present within an adjustment path of the vehicle part, and wherein said control unit is configured to use a signal from said distance sensor indicating an absence of an obstacle in the adjustment path as the additional criterion.

5. The adjusting apparatus according to claim 1, wherein said control unit is configured to respond to the second control signal by using a signaling unit to output a confirmation signal.
